(19) United States
(12) Patent Application Publication
(10) Pub. No.: US 2004/0075862 A1
(43) Pub. Date: Apr. 22, 2004

(54) Image forming apparatus and driving method thereof

(75) Inventor: Yong-geun Kim, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/670,325

(22) Filed: Sep. 26, 2003

(30) Foreign Application Priority Data
Oct. 16, 2002 (KR) 2002-63112

(51) Int. Cl. G06F 3/12; G06F 15/00; G06F 13/00

(52) U.S. Cl. 358/1.15; 358/1.16

(57) ABSTRACT

An image forming apparatus performing a printing operation with respect to printing data transmitted from an external device, the image forming apparatus including a printing engine unit performing the printing operation with respect to the printing data, a printing control unit connectable to the external device, controlling the printing engine unit to perform the printing operation with respect to the printing data transmitted from the external device, and an image processing unit removably disposed in the image forming apparatus, transforming the printing data transmitted from the external device to image data to be processed by the printing engine unit, wherein the image processing unit is connected to the printing control unit through a local BUS when the image processing unit is mounted in the image forming apparatus.

### CROSS-REFERENCE TO RELATED APPLICATIONS

This application claims the benefit of Korean Application No. 2002-63112, filed Oct. 16, 2002, in the Korean Intellectual Property Office, the disclosure of which is incorporated herein by reference.

### BACKGROUND OF THE INVENTION

1. Field of the Invention

The present invention relates to an image forming apparatus and a driving method thereof, and, more particularly, to an image forming apparatus, and a driving method thereof, in which a printing performance is easily upgraded, and new functions are easily added.

2. Description of the Related Art

Generally, an image forming apparatus such as a photocopier, a printer, a facsimile machine, and a multi-function device incorporating functions of the photocopier, the printer, and the facsimile machine into one device, commonly has a printing function.

FIG. 1 is a block diagram showing a conventional image forming apparatus.

Referring to FIG. 1, an image forming apparatus 50 includes an image processing unit 60 and an image forming engine unit 70. The image processing unit 60 transforms printing data transmitted from an external device such as a host computer 10 and an image scanner (not shown) to image data to be processed by the image forming engine unit 70, and transmits the transformed data to the image forming engine unit 70.

As shown in FIG. 2, the image processing unit 60 includes an interface 61 interfacing between the image processing unit 60 and the host computer 10, a central processing unit 63, which is called “CPU” hereinbelow, controlling general operations of the image processing unit 60, a ROM 65 storing therein a control program of the CPU 63 and various application programs, a RAM 67 contemporarily storing data that is generated during the image processing performed with respect to the printing data transmitted from the host computer 10, and data that results from a program execution of the CPU 63, and an EEPROM 69 storing management information on an initial condition and a control establishment value of the image processing unit 60.

Referring back to FIG. 1, the image forming engine unit 70 includes an engine control portion 80 and an engine portion 90.

The engine control portion 80 controls a general driving condition of the engine portion 90 in accordance with a control of the image process unit 60.

As show in FIG. 3, the engine control portion 80 includes a ROM 85 storing a control program that is executed initially when the image forming engine portion 70 is turned-on, or when it is reset, and a control program controlling the image forming engine portion 70, a CPU 83 controlling a system in accordance with the programs stored in the ROM 85, a mechatronics interface 81 interfacing between the CPU 83 and the engine portion 90, a RAM 87 temporarily storing the data resulting from the program execution of the CPU 83, and an EEPROM 89 storing data for a control of the image forming engine unit 70, and data for a management of the operation state of the image forming engine unit 70.

The engine portion 90 performs a printing operation with respect to an image processed by the image processing unit 60. For example, the engine portion 90, employing an electrophotographic method, prints the image on a printing medium through a series of processes of electric charging, laser scanning, developing, transferring, and fusing.

In order to improve the printing performance of the conventional image forming apparatus 50, or to add a new function, the image forming apparatus 50 is required to be upgraded. The printing performance of the image forming apparatus 50 generally depends on the performance of the image processing unit 60, and the quality of the printed image depends on the performance of the image forming engine unit 70.

The conventional image forming apparatus 50 has to update the control program stored in the ROM 65 in order to add a new function, and has to add to the memory of the RAM 67 in order to improve the printing performance. Also, in order to add an interface function, an interface card has to be upgraded.

However, the upgrade as described above does not guarantee multi-functionality and high performance of the image forming apparatus 50, and also does not allow the CPU 63 to be upgraded. Meanwhile, for the high performance of the image forming apparatus 50, a high fabrication cost is required.

### SUMMARY OF THE INVENTION

The present invention has been developed in order to solve the above and/or other problems in the related art. Accordingly, an aspect of the present invention is to provide an image forming apparatus and a driving method thereof capable of being upgraded for high performance and multi-functionallity, even if it is produced at a low cost.

Additional aspects and/or advantages of the invention will be set forth in part in the description which follows and, in part, will be obvious from the description, or may be learned by practice of the invention.

The above and/or other aspects of the present invention are achieved by providing an image forming apparatus performing a printing operation with respect to printing data transmitted from an external device. The image forming apparatus comprises a printing engine unit performing the printing operation with respect to the printing data, a printing control unit connectable to the external device, controlling the printing engine unit to perform the printing operation with respect to the printing data transmitted from the external device, and an image processing unit removably disposed in the image forming apparatus, transforming the printing data transmitted from the external device to image data to be processed by the printing engine unit. The image processing unit is connected to the printing control unit through a local BUS when the image processing unit is mounted in the image forming apparatus.

Meanwhile, when the image processing unit is not mounted in the image forming apparatus, the printing control unit may control the printing engine unit to perform the printing operation with respect to image data image-processed and transmitted from the external device.

The image processing unit may comprise a first interface transmitting/receiving the printing data to/from the external device, a central processing unit controlling general operations of the image forming apparatus, and a storage portion storing a control program to control a central processing unit and the image processing unit and the image data that is generated during the image processing.

The image processing unit may transform the printing data to the image data to be processed by the printing engine unit on receipt of the printing data from the external device through the first interface, and outputs the transformed image data to the printing control unit.

The printing control unit may control the printing engine unit to perform the printing operation with respect to the image data transformed and transmitted from the image processing unit.

Meanwhile, the above and/or other aspects are achieved by providing a driving method of an image forming apparatus performing a printing operation with respect to printing data transmitted from an external device. The driving method comprising detecting whether an image processing unit is mounted in the image forming apparatus, wherein the image processing unit transforms the printing data to image data to be processed by a printing engine unit performing the printing operation, controlling the image processing unit to transform the printing data transmitted from the external device to the image data in response to the image processing unit being mounted in the image forming apparatus, and outputting the transformed data to a printing engine unit, and controlling the printing engine unit to perform the printing operation with respect to the image data received.

Meanwhile, the controlling the printing engine unit to perform the printing operation with respect to the image data received may comprise receiving the image data image-processed and transmitted from the external device in response to the image processing unit not being mounted in the image forming apparatus.

### BRIEF DESCRIPTION OF THE DRAWINGS

These and other aspects and/or advantages of the invention will become apparent and more readily appreciated from the following description of the preferred embodiments, taken in conjunction with the accompanying drawings of which:

FIG. 1 is a block diagram showing a conventional image forming apparatus;

FIG. 2 is a block diagram showing the image processing unit of FIG. 1;

FIG. 3 is a block diagram showing the engine controlling portion of FIG. 1;

FIG. 4 is a block diagram showing an image forming apparatus according to an embodiment of the present invention;

FIG. 5 is a block diagram showing a high performance image forming apparatus structured in a manner that the image forming apparatus of FIG. 4 employs an image processing unit according to an embodiment of the present invention;

FIG. 6 is a block diagram showing the image processing unit of FIG. 5; and

FIG. 7 is a flowchart showing a driving method of the image forming apparatus according to an embodiment of the present invention.

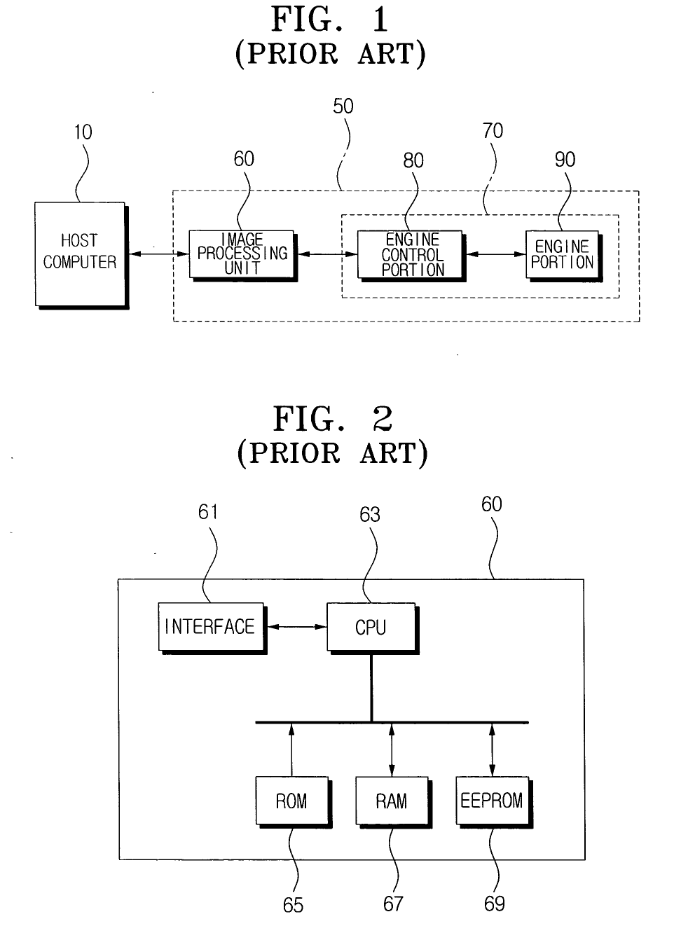

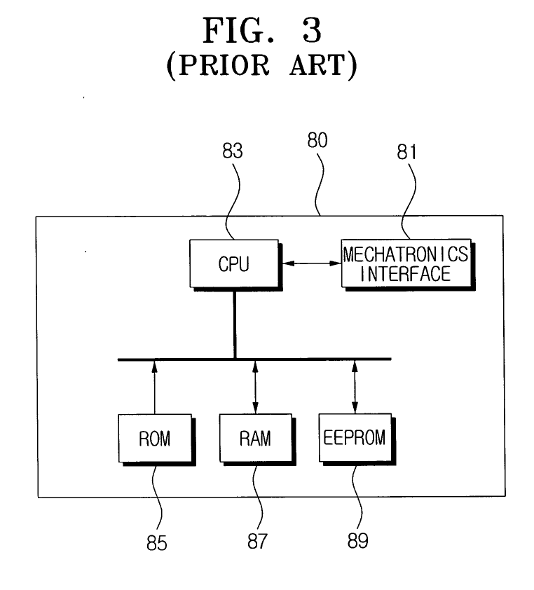

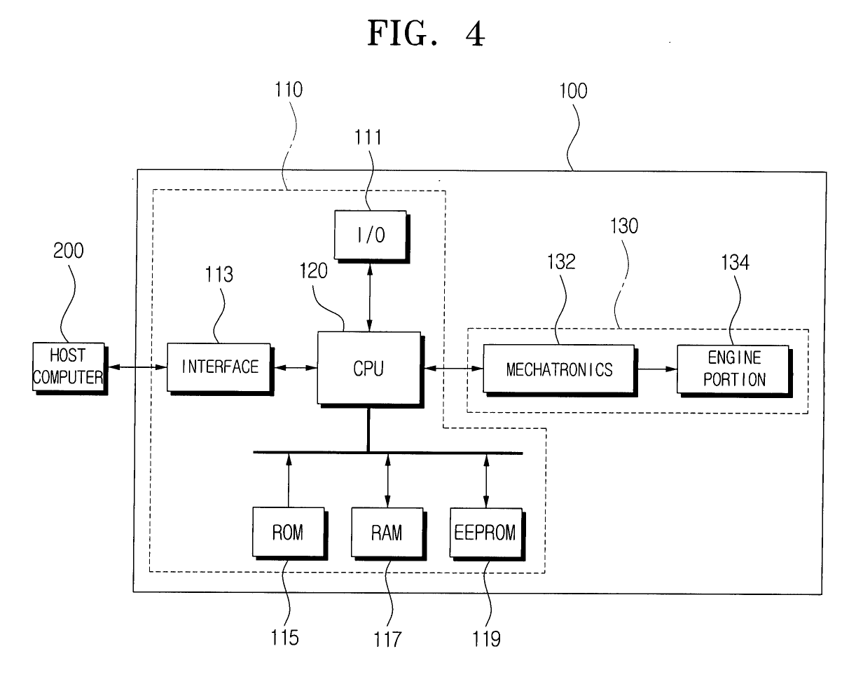

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

FIG. 4 is a block diagram showing an image forming apparatus which is produced at a low cost according to an embodiment of the present invention.

Referring to FIG. 4, the image forming apparatus 100 that is produced at a low cost includes a printing control unit 110 and an image forming engine unit 130.

The image forming apparatus 100 is an integrated form of the image processing unit 60 of the image forming apparatus 50 with the image forming engine unit 70, and an image processing operation with respect to printing data is generally performed by a host computer 200.

The printing control unit 110 controls the image forming engine unit 130 to perform a printing operation with respect to image data which is image-processed by an external device such as the host computer 200.

The printing control unit 110 includes an I/O 111, an interface 113, a ROM 115, a RAM 117, an EEPROM 119, and a CPU 120.

The I/O 111 is input with a control signal for controlling the image forming apparatus 100, and outputs to a display device (not shown) an output signal that results from the operations of the image forming apparatus 100.

The interface 113 supports data communication between the host computer 200 and the CPU 120, which are connected to each other through a communication interface (not shown). The communication interface may employ a USB module capable of bi-directional parallel interface, by way of an example.

The ROM 115, which is a non-volatile memory, stores various control programs that are required to perform the functions of the image forming apparatus 100.

The RAM 117 stores image data that is transmitted from the host computer 200, and data that is generated during the operations of the image forming apparatus 100.

The EEPROM 119 stores data for a control of the image forming engine unit 130, and data for management of an operation state of the image forming engine unit 130.

With a power supply to the image forming apparatus 100, the CPU 120 controls general operations of the image forming apparatus 100 in accordance with the control program stored in the ROM 115. Also, the CPU 120 transmits image data which is image-processed and transmitted from the host computer 200 through the interface 113 to the image forming engine unit 130.

The image forming engine unit 130 includes a mechatronics portion 132 and a printing engine portion 134.

The mechatronics portion 132 controls the printing engine portion 134 to perform a printing operation with respect to the image data received from the CPU 120 in accordance with the control of the CPU 120.

The printing engine portion 134 performs a printing operation with respect to the image data according to the control of the mechatronics portion 132. For example, in the case that the printing engine portion 134 employs an electrophotographic method, the printing operation is performed in a series of processes of electric charging, laser scanning, developing, transferring, and fusing. Here, since the printing method employing the electrophotographic method is well known to those skilled in the related art, detailed descriptions will be omitted.

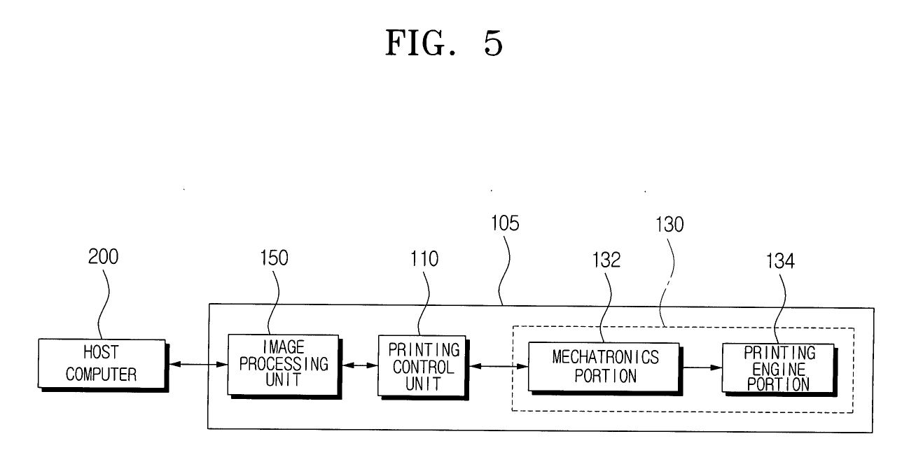

FIG. 5 is a block diagram showing a high performance image forming apparatus 105 structured in a manner that the image producing apparatus produced at a low cost employs an image processing unit to add a new function and improve printing performance. With respect to the elements identical to those of FIG. 4, like reference numerals are assigned and descriptions thereof will be omitted.

Referring to FIG. 5, a high performance image forming apparatus 105 includes an image processing unit 150, a printing control unit 110, and an image forming engine unit 130. The image processing unit 150 is removably disposed in the image forming apparatus 105, and transforms data coded and transmitted from a host computer 200 into image data to be processed by a printing engine portion 134.

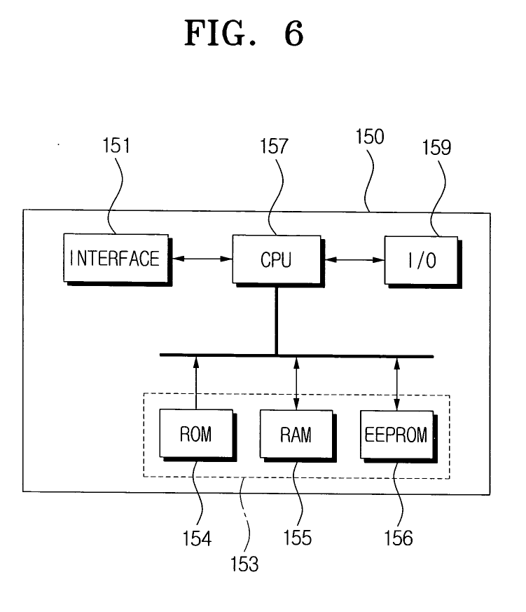

FIG. 6 is a block diagram showing the image processing unit 150 of FIG. 5. Referring to FIG. 6, the image processing unit 150 includes an interface 151, a storage portion 153, a CPU 157, and an I/O 159.

The interface 151 is connected to the host computer 200 and the CPU 157 therebetween, for interfacing input/output data between the host computer 200 and the CPU 157.

The storage portion 153 includes a ROM 154, a RAM 155, and an EEPROM 156. The ROM 154 stores a control program of the CPU 157, various control programs required to perform functions of the image processing unit 150, and font information for text.

The RAM 155 temporarily stores data that is generated during image processing operations performed with respect to printing data transmitted from the host computer 200 through the interface 151, and data that results from the program execution of the CPU 157. The EEPROM 156 stores data for control of the image processing unit 150, and manages information such as a control establishment value.

In accordance with the control program stored in the ROM 154, the CPU 157 transforms code data that is transmitted from the host computer 200 through the interface 151 into image data to be processed by the printing engine portion 134, and outputs the transformed data to the printing control unit 110.

When the image processing unit 150 is mounted in the image forming apparatus 105, it is mutually connected with the printing control unit 110 through a local BUS.

If the image forming apparatus 105 according to an embodiment of the present invention does not employ the image processing unit 150, it controls the printing engine portion 134 to perform the printing with respect to the image data image-processed and transmitted from the host computer 200. In this case, it is preferred that the host computer 200 is connected with the interface 113 of the printing control unit 110.

Meanwhile, if the image processing unit 150 is mounted in the image forming apparatus 105, it transforms printing data transmitted from the host computer 200 through the interface 151 into data to be processed by the printing engine portion 134, and outputs the transformed data to the printing control unit 110. In this case, it is preferred that the host computer 200 is connected to the interface 151 of the image processing unit 150.

The printing control unit 110 controls the image forming engine unit 130 to perform a printing operation with respect to the image data transmitted from the image processing unit 150.

The mechatronics portion 132 controls the printing engine portion 134 to perform a printing operation with respect to the image data received from the CPU 157 according to the control of the CPU 157. The printing engine portion 134 performs a printing operation with respect to the image data according to the control of the mechatronics portion 132.

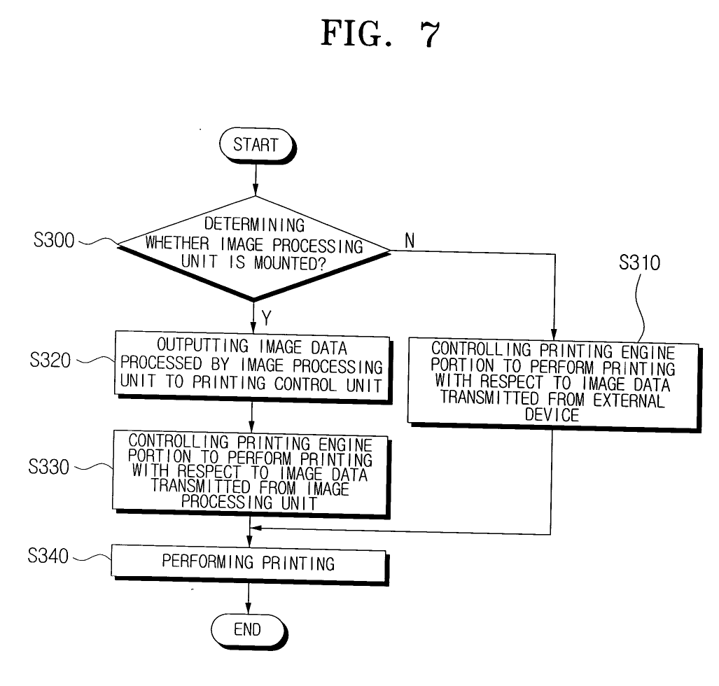

Hereinafter, a driving method of the image forming apparatus according to an embodiment of the present invention with reference to FIG. 7 will be described.

Referring to FIG. 7, with a power supply to the image forming apparatus 100, it is determined whether or not the image processing unit 150 is mounted in the image forming apparatus 100 (S300). There is provided a sensor (not shown), disposed at a position in which the image processing unit 150 is mounted, for detecting whether or not the image processing unit 150 is mounted in the image forming apparatus 100. Alternatively, when the image processing unit 150 is mounted to be mutually connected to the printing control unit 110 through the local BUS, a signal communication occurs in the local BUS. Due to the presence of the signal communication, it is detected that the image processing unit 150 is mounted in the image forming apparatus 100.

If it is determined that the image processing unit 150 is not mounted in the image forming apparatus 100 in S300, the printing control unit 110 controls the printing engine portionl34 to perform a printing operation with respect to image data that is image-processed and transmitted from the host computer 200 through the interface 113 (S310).

Meanwhile, if it is determined that the image processing unit 150 is mounted in the image forming apparatus in S300, the CPU 157 transforms code data transmitted from the host computer 200 through the interface 151 to image data to be processed by the printing engine portion 134 according to the control program stored in the ROM 154, and outputs the transformed data to the printing control unit 110 (S320).

The printing control unit 110 controls the printing engine portion 134 to perform the printing operation with respect to the image data received from the image processing unit 150 (S330).

Under the control of the printing control unit 110, the printing engine portion 134 performs the printing operation with respect to the image data (S340).

As described above, the image forming apparatus according to an embodiment of the present invention is embodied by the image forming apparatus 100, produced at a low cost, or the high performance image forming apparatus 105, produced at a higher cost, according to whether the image processing unit 150 is mounted or not.

According to the image forming apparatus and the driving method thereof, by mounting the image processing unit 150, and thus providing multi-functionality and higher performance, in the image forming apparatus produced at a low cost, it can be easily upgraded to a high performance image forming apparatus. Accordingly, it is easy to upgrade the image forming apparatus for the addition of the new function and the improvement of the printing performance.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus performing a printing operation with respect to printing data transmitted from an external device, the image forming apparatus comprising:
a printing engine unit performing the printing operation with respect to the printing data;
a printing control unit connectable to the external device, controlling the printing engine unit to perform the printing operation with respect to the printing data transmitted from the external device; and
an image processing unit removably disposed in the image forming apparatus, transforming the printing data transmitted from the external device to image data to be processed by the printing engine unit;
wherein the image processing unit is connected to the printing control unit through a local BUS when the image processing unit is mounted in the image forming apparatus.

2. The image forming apparatus of claim 1, wherein the printing control unit controls the printing engine unit to perform the printing operation with respect to data that is image-processed and transmitted from the external device in response to the image processing unit not being mounted in the image forming apparatus.

3. The image forming apparatus of claim 1, wherein the image processing unit comprises:
a first interface transmitting/receiving the printing data to/from the external device;
a central processing unit controlling general operations of the image forming apparatus; and
a storage portion storing a control program to control the image processing unit and the image data that is generated during the image processing.

4. The image forming apparatus of claim 3, wherein the image processing unit transforms the printing data to the image data to be processed by the printing engine unit upon receipt of the printing data from the external device through the first interface, and outputs the transformed image data to the printing control unit, and the printing control unit controls the printing engine unit to perform the printing operation with respect to the image data transformed and transmitted from the image processing unit.

5. The image forming apparatus of claim 3, wherein the storage portion comprises a ROM storing the control program of the central processing unit.

6. The image forming apparatus of claim 3, wherein the storage portion comprises a RAM temporarily storing the data generated during the image processing.

7. The image forming apparatus of claim 3, wherein the storage portion comprises an EEPROM storing image processing unit control data, and managing a control establishment value.

8. The image forming apparatus of claim 3, wherein the storage portion comprises:
a ROM storing the control program of the central processing unit;
a RAM temporarily storing the data generated during the image processing; and
an EEPROM storing image processing unit control data, and managing a control establishment value.

9. The image forming apparatus of claim 1, wherein the printing control comprises a second interface that connects the printing control unit to the external device.

10. The image forming apparatus of claim 9, wherein the second interface comprises a USB unit.

11. The image forming apparatus of claim 1, wherein the printing engine unit comprises a mechatronics portion and a printing engine portion.

12. A driving method of an image forming apparatus performing a printing operation with respect to printing data transmitted from an external device, the driving method comprising:
detecting whether an image processing unit is mounted in the image forming apparatus, wherein the image processing unit transforms the printing data to image data to be processed by a printing engine unit performing the printing operation;
controlling the image processing unit to transform the printing data transmitted from the external device to the image data in response to the image processing unit being mounted in the image forming apparatus, and outputting the transformed data to a printing engine unit; and
controlling the printing engine unit to perform the printing operation with respect to the image data received.

13. The driving method of claim 12, wherein the controlling the printing engine unit to perform the printing operation with respect to the image data received comprises receiving the image data image-processed and transmitted from the external device in response to the image processing unit not being mounted in the image forming apparatus.

14. The driving method of claim 12, wherein the detecting whether the image processing unit is mounted in the image forming apparatus is performed by a sensor disposed at a position in which the image processing unit is mounted.

15. The driving method of claim 12, wherein the detecting whether the image processing unit is mounted in the image forming apparatus is performed by a signal communication in a local BUS, wherein the image processing unit is connected to the image forming apparatus through the local BUS.

16. An image forming apparatus performing a printing operation with respect to data transmitted from an external device, the image forming apparatus comprising:
a printing control unit; and
a removable image processing unit transforming the data transmitted from the external device and transmitting the data to the printing control unit;
wherein the printing control unit is connectable to the image processing unit and the external device, and receives image processed data directly from the external device in response to the absence of the removable image processing unit.

17. An image processing unit of an image forming apparatus, the image processing unit comprising:
an interface for transmission/reception of data with the external device;
a central processing unit controlling the image forming apparatus; and
a storage portion storing a program to control the central processing unit and data generated during image processing;
wherein the image processing unit is removable from the image forming apparatus.

18. An image forming system, comprising:
an external device; and
an image forming apparatus comprising:
a printing control unit, and
a removable image processing unit transforming data transmitted from the external device and transmitting the data to the printing control unit,
wherein the printing control unit is connectable to the image processing unit and the external device, and receives image processed data directly from the external device in response to the absence of the removable image processing unit;
wherein image forming system operates with or without the removable image processing unit.
